(19) United States
(12) Patent Application Publication
(10) Pub. No.: US 2006/0055615 A1
(43) Pub. Date: Mar. 16, 2006

(54) Multi-band dipole array antenna

(76) Inventor: Tung-Sheng Zhou, Jhudong Township (TW)

Correspondence Address: SUPREME PATENT SERVICES, P.O. BOX 2339, SARATOGA, CA, 95070-0339, US

(21) Appl. No.: 10/940,215

(22) Filed: Sep. 13, 2004

(51) Int. Cl. H01Q 9/16

(52) U.S. Cl. 343/790; 343/792

(57) ABSTRACT

A multi-band dipole array antenna is constructed by coupling a coaxial feed line in an axial direction thereof with at least two PCB-antenna sets connected in series. By adjusting or setting the distance between the PCB antennas and the length of the coaxial feed line, a stable radiation transmitting-receiving performance with an omni-directional efficacy and a high radiation gain for at least two wavebands can be achieved.

### BACKGROUND OF THE INVENTION

1. Field of the Invention

The present invention relates to a PCB-antenna, particularly to a multi-band dipole array antenna with omni-directional radiation efficiency and high gain, comprised of a coaxial feed line coupled in an axial direction thereof with at least two PCB-antenna sets connected in series.

2. The Prior Arts

The structure of a generic ½(λ) dipole-antenna is usually composed of either a pair of positive and negative poles or signal and ground terminals based on air or PCB, wherein the symbol λ represents for wavelength herein. The distance between two poles is basically ¼(λ) of a carrier frequency, and in case 2.45 GHz is applied, it is possible to provide a radiation gain of 2.0-3.0 dBi approximately, which, as the radiation-receiving capability of a ½(λ) dipole-antenna, is considered insufficient for a communication equipment needing a longer effective communication distance.

For increasing the radiation gain to enlarge the valid range accordingly, the inventor disclosed in Taiwan Patent Application No. 91206760, which is now granted a patent in Taiwan and is particularly illustrated in FIG. 1. As shown, the conventional dipole antenna is comprised of a single-sleeve component 20 and at least a dual-sleeve component 30. The single-sleeve component 20 is made of an electrically conductive metal and has an end assembled together with an antenna coupling 40. The single-sleeve component 20 is composed of a sleeve 21 of ¼(λ) long and a hollow shaft cylinder 22. The dual-sleeve component 30 is also made of an electrically conductive metal and is comprised of two sleeves 31 and a hollow shaft cylinder 32. The hollow shaft cylinder 32 is ¾(λ) long, while the sleeve 31 is ¼(λ) long.

The radiation gain of the conventional antenna disclosed in Taiwan Patent Application No. 91206760 is measured as 3.0, 6.0, 9.0, and 12.0 dBi, in case 1, 2, 4, or 8 pieces of the dual-sleeve component 30 are arranged respectively under a frequency of 2.45 GHz. Therefore, it can be known from above data that the radiation-receiving performance has been significantly improved though. However, there are still some drawbacks in this conventional antenna, including: (1) It can be made useful for transmitting-receiving radiation only in a limited single waveband. (2) Since the structural body is built with metallic sleeve components, the fabrication cost is relatively high. (3) As the volume is bulkier according to the above point (2), the dipole antenna is awkward for built-in arrangement. (4) When 9.0 dBi is desired, 4 dual-sleeve components are required to make the antenna as long as (3+¾)(λ), which is obviously overlong for built-in arrangement.

### SUMMARY OF THE INVENTION

The primary object of the present invention is to provide a multi-band dipole array antenna for multi-band radiation transmitting-receiving performance by adjusting the span of a PCB antenna.

Another object of the present invention is to provide a multi-band dipole array antenna having an omni-directional radiation transmitting-receiving efficacy and a high radiation gain.

Yet another object of the present invention is to provide a multi-band dipole array antenna, which is built easily with simple components to have the fabrication cost lowered.

Yet another object of the present invention is to provide a multi-band dipole array antenna, which is small in size and short in length to meet the conditions for built-in arrangement.

In order to realize above objects, a multi-band dipole array antenna of the present invention is constructed by coupling a coaxial feed line in an axial direction thereof with at least two PCB-antenna sets connected in series.

Therefore, we may have now a multi-band dipole array antenna, which is built small and short easily at a low cost, particularly for meeting the requirements of built-in arrangement, and is made useful for a stable multi-band radiation transmitting-receiving performance.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a schematic view showing a conventional dipole antenna disclosed in Taiwan Patent Application No. 91206760;

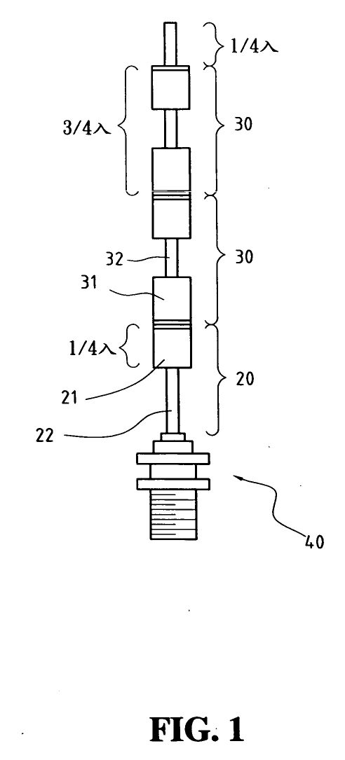

FIG. 2 is a schematic view showing a dipole antenna in accordance with the present invention;

FIG. 3 shows the Return Loss of test performed on the embodiment of the present invention;

FIG. 4 shows the voltage standing-wave ratio (VSWR) of the embodiment of the present invention;

FIG. 5 shows a 2.45 GHz E-plane field pattern of the embodiment of the present invention;

FIG. 6 shows a 2.45 GHz H-plane field pattern of the embodiment of the present invention;

FIG. 7 shows a 5.25 GHz E-plane field pattern of the embodiment of the present invention; and

FIG. 8 shows a 5.25 GHz H-plane field pattern of the embodiment of the present invention.

### DETAILED DESCRIPTION OF THE PREFERRED EMBODIMENT

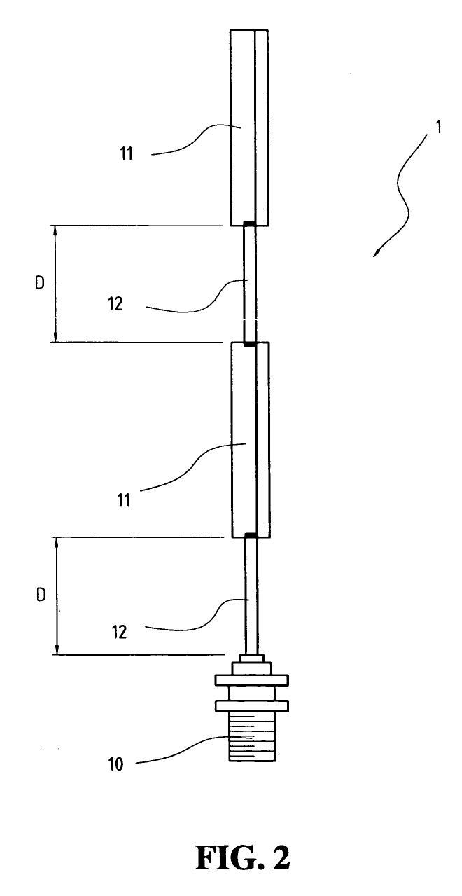

With reference to the drawings and in particular to FIG. 2, a multi-band dipole array antenna constructed in accordance with the present invention, generally designated with reference numeral 1, comprises a coaxial feed line 12 connected in series with at least two sets of PCB antenna 11 spaced by a distance D. The PCB antenna 11 and the coaxial feed line 12 are aligned in the same axial direction.

In application, an antenna coupling 10 is electrically connected to one end of the coaxial feed line 12 and the distance D between the PCB antennas 11 is adjusted to equal the length of the coaxial feed line 12 so that a stable radiation transmitting-receiving performance for at least two wavebands is achievable.

The distance D, which is identical to the length of the coaxial feed line 12, is 3×¼(λ) long in the 2.45 GHz waveband (where λ represents wavelength associated with the frequency), while it is 5×¼(λ) in the 5.25 GHz waveband.

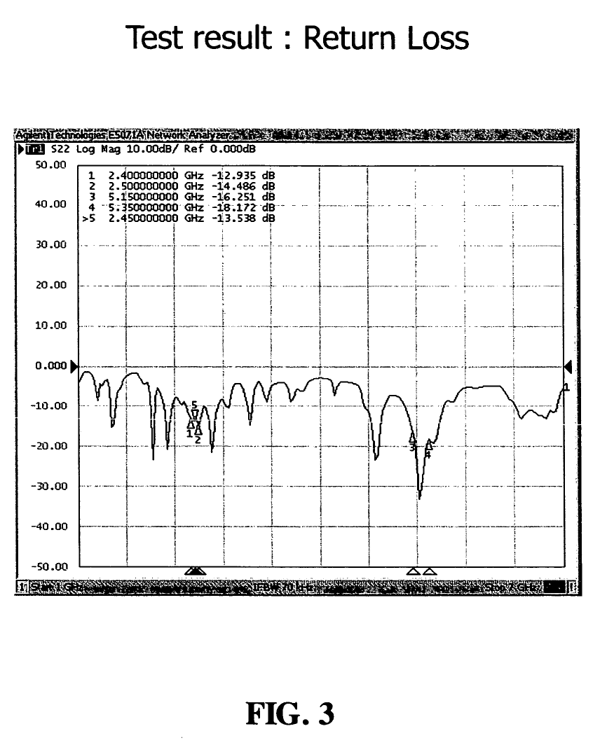

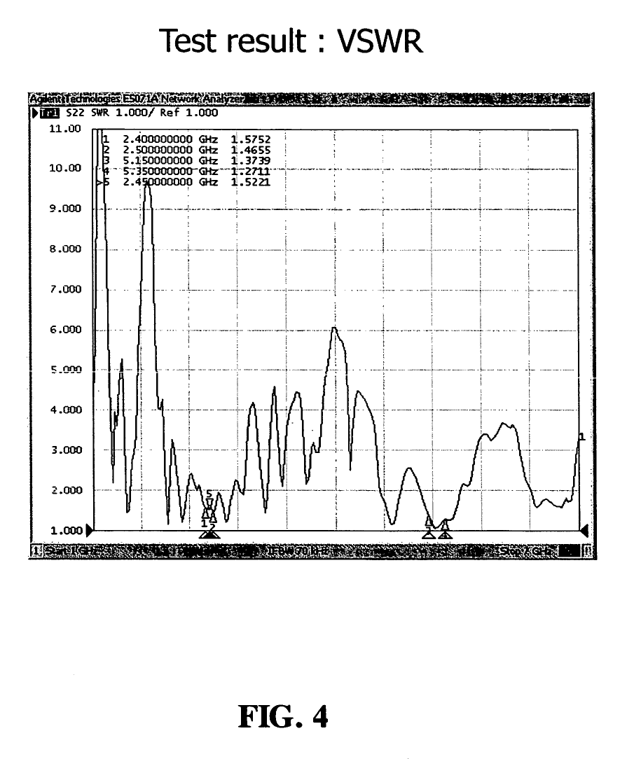

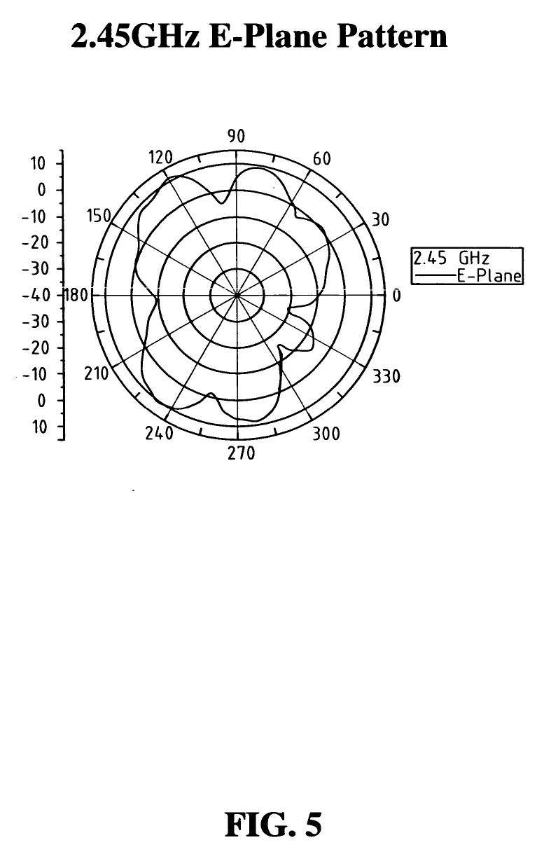

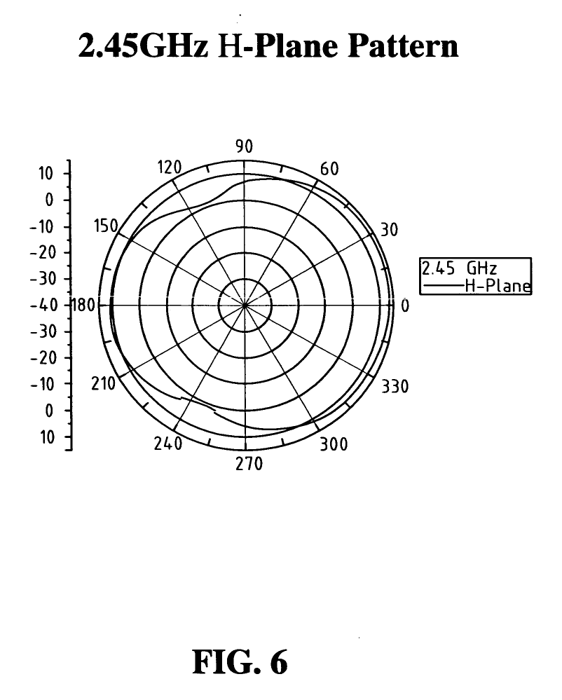

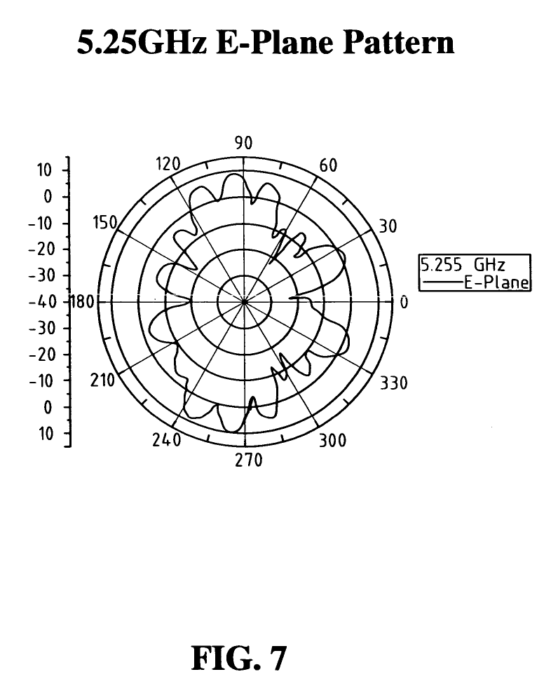

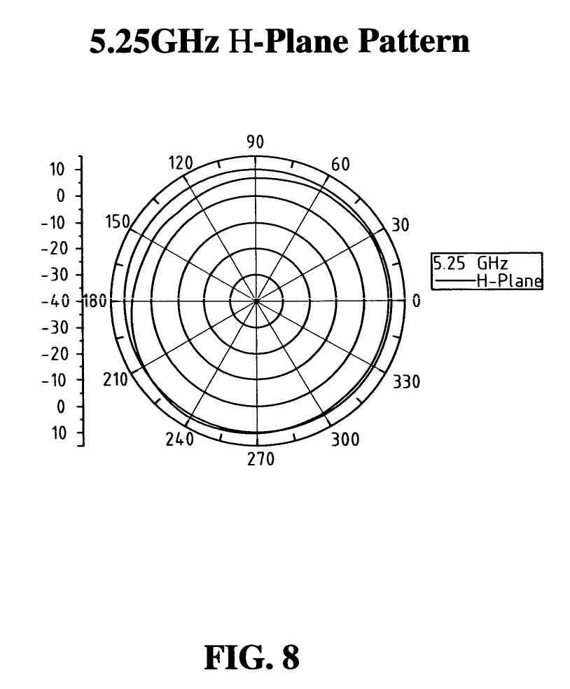

When reference is made to the test on Return Loss shown in FIG. 3 and VSWR shown in FIG. 4 for examining efficacy of the embodiment, a stable radiation transmitting-receiving performance is found at least in 2.45 GHz and 5.25 GHz wavebands. Also, a radiation gain about 8.0 dBi is found for both the 2.45 GHz and 5.25 GHz wavebands, according to an E-plane and an H-plane field pattern of 2.45 GHz shown in FIGS. 5 and 6, and of 5.25 GHz in FIGS. 7 and 8, respectively.

Thus, an omni-directional efficacy for transmitting-receiving radiation and a high radiation gain are verified according to the tests made to the embodiment of the present invention.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A multi-band dipole array antenna, comprising a coaxial feed line having a predetermined length coupled with two PCB-antenna sets connected in series, the PCB antenna sets being aligned in an axial direction with the coaxial feed line, the PCB antennas being spaced a distance substantially equal to the length of the coaxial feed line, wherein by adjusting setting the distance between the PCB antennas and the length of the coaxial feed line, a stable radiation transmitting-receiving performance with an omni-directional efficacy and a high radiation gain for at least two wavebands is achievable.

2. The multi-band dipole array antenna as claimed in claim 1, wherein both the distance between the PCB antennas and the length of the coaxial feed line are 3×¼(λ) long, where λ is the wavelength of the waveband 2.45 GHz.

3. The multi-band dipole array antenna as claimed in claim 1, wherein both the distance between the PCB antennas and the length of the coaxial feed line are 5×¼(λ)long, where λ is the wavelength of the waveband 5.25 GHz.
